(19) United States
(12) Patent Application Publication
(10) Pub. No.: US 2012/0015116 A1
(43) Pub. Date: Jan. 19, 2012

(54) PHOTOREACTIVE POLYMER AND PREPARATION METHOD THEREOF

(76) Inventors: Dai-Seung CHOI, Yuseong-gu (KR); Sung-Ho CHUN, Seo-gu (KR); Young-Chul WON, Seo-gu (KR); Dong-Woo YOO, Yuseong-gu (KR)

(21) Appl. No.: 13/183,871

(22) Filed: Jul. 15, 2011

(30) Foreign Application Priority Data
Jul. 16, 2010 (KR) 10-2010-0069126
Jun. 23, 2011 (KR) 10-2011-0061116

(51) Int. Cl. C08F 32/08; C09K 19/02; C08F 232/04

(52) U.S. Cl. 428/1.2; 526/281; 526/309

(57) ABSTRACT

This disclosure relates to photoreactive polymer exhibiting more rapid photoreaction speed and excellent alignment, a preparation method thereof, and an alignment layer comprising the same. The photoreactive polymer comprises a specific repeat unit including an azo type functional group in the content of 50 mole % or more of the total polymer.

### BACKGROUND OF THE INVENTION

(a) Field of the Invention

This disclosure relates to photoreactive polymer exhibiting more rapid photoreaction speed and excellent alignment, a preparation method thereof, and an alignment layer comprising the same.

(b) Description of the Related Art

Recently, a liquid crystal display appears as the most competitive display capable of replacing a Braun tube due to the light weight and low electric consumption. Particularly, since a thin film transistor liquid crystal display (TFT-LCD) that is driven by a thin film transistor independently drives each pixel, it has excellent response speed of liquid crystal and may realize a high definition video picture, and thus, the application ranges are being gradually extended to a laptop computer, a wall-mountable TV, and the like.

In order that liquid crystal may be used as an optical switch in the TFT-LCD, liquid crystal should be initially aligned in a specific direction on a layer wherein a thin film transistor is formed innermost of the display cell, and a liquid crystal alignment layer is used therefor.

For the liquid crystal alignment, a rubbing process has been applied wherein heat resistant polymer such as polyimide, and the like is coated on a transparent glass to form a polymer alignment layer, and the alignment layer is rubbed and aligned while rotating a rotation roller wound with a rubbing cloth such a nylon, rayon, and the like.

However, since the rubbing process may generate mechanical scratch on the surface of liquid crystal aligning agent during rubbing, or it may generate high static electricity, a thin film transistor may be destroyed. Further, fine fiber, and the like generated in the rubbing cloth may cause faulty, thus being an obstacle to yield improvement.

To overcome the problems of the rubbing process and achieve an innovation in terms of production, liquid crystal alignment by polarized light such as UV (hereinafter, referred to as “photo-alignment”) has been newly designed.

The photo-alignment refers to a mechanism of forming a photo-polymerizable liquid crystal alignment layer wherein photosensitive groups bonded to a specific photoreactive polymer cause a photoreaction by linearly polarized UV, during which process a polymer main chain is aligned in a specific direction, thus aligning liquid crystal.

Representative examples of the photo-alignment includes photo-alignment by photo-polymerization announced by M. Schadt, et al (Jpn. J. Appl. Phys., Vol 31., 1992, 2155), Dae S. Kang, et al (U.S. Pat. No. 5,464,669), and Yuriy Reznikov (Jpn. J. Appl. Phys. Vol. 34, 1995, L1000). The photo-aligned polymers used in the patents and papers are poly cinnamate type polymer such as PVCN (poly(vinyl cinnamate)) or PVMC (poly(vinyl methoxycinnamate)). If it is photo-aligned, a double bond [2+2] of cinnamate is subjected to a cycloaddition-reaction [2+2] by irradiated UV to form cyclobutane, and thereby, anisotropy is formed to align liquid crystal molecules in one direction to induce alignment of liquid crystal.

However, the above explained photo-aligned polymers have disadvantages that it may deteriorate alignment stability or thermal stability of the alignment layer because thermal stability of the polymer main chain is low, or liquid crystal alignment may be insufficient. For example, polymer having an acryl type main chain may largely deteriorate stability of the alignment layer due to low thermal stability, and if a photosensitive group is restricted in the main chain, it does not rapidly respond to irradiated polarized light thus deteriorating liquid crystal alignment or alignment speed. As such, if the liquid crystal alignment or alignment speed is deteriorated, process efficiency may decrease or liquid crystal alignment of the liquid crystal display device may be insufficient, thus decreasing dichloric ratio and deteriorating contrast.

Meanwhile, photoreactive polymer comprising an azo group-bonded repeat unit as a part of the repeat units has been suggested in Bull. Korean Chem. Soc. 2002, Vol. 23, 957. However, the photoreactive polymer also exhibits insufficient alignment, and it has slow photoreaction speed thus decreasing process efficiency or deteriorating contrast of the liquid crystal display device.

### SUMMARY OF THE INVENTION

The present invention provides photoreactive polymer exhibiting more rapid photoreaction speed and excellent alignment, and a method of preparing the same.

The present invention also provides an alignment layer comprising the above photoreactive polymer, which may be preferably included in a liquid crystal display device, and the like.

The present invention provides photoreactive polymer comprising a repeat unit of the following Chemical Formula 3 or 4 in the content of 50 mole % or more of the total polymer:

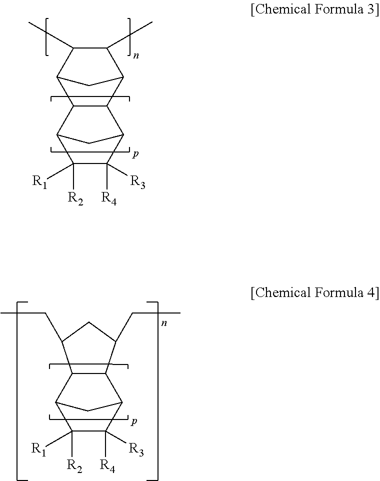

In each of the Chemical Formulae 3 and 4,

n is 50 to 5000, p is an integer of from 0 to 4,

at least one of R₁, R₂, R₃, and R₄ is a radical selected from the group consisting of the following Chemical Formulae 1a, 1b, and 1c, the remaining R₁, R₂, R₃, and R₄ are independently selected from the group consisting of hydrogen; halogen; a substituted or unsubstituted C1-20 alkyl group; a substituted or unsubstituted C2-20 alkenyl group; a substituted or unsubstituted C2-20 alkynyl; a substituted or unsubstituted C3-12 cycloalkyl; a substituted or unsubstituted C6-40 aryl; and a polar functional group including at least one selected from oxygen, nitrogen, phosphorous, sulfur, silicon, and boron, and

if R₁ to R₄ are not hydrogen; halogen; or a polar functional group, R₁ and R₂, or R₃ and R₄ may be connected to each other to form a C1-10 alkylidene group, or R₁ or R₂ may be connected to one of R₃ and R₄ to form a C4-12 saturated or unsaturated ring, or a C6-24 aromatic ring,

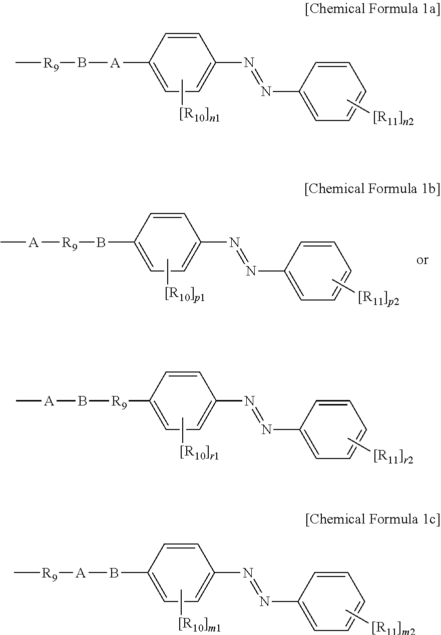

in each of the Chemical Formulae 1a, 1b, and 1c,

n1, p1, r1 and m1 is independently an integer of from 0 to 4; n2, p2, r2 and m2 are independently an integer of from 0 to 5,

A is a substituted or unsubstituted C1-20 alkylene group, a carbonyl, a carboxy, a substituted or unsubstituted C6-40 arylene group, or a bond,

B is oxygen, sulfur, —NH—, or a bond,

R₉ is a bond, a substituted or unsubstituted C1-20 alkylene group, a substituted or unsubstituted C2-20 alkenylene group, a substituted or unsubstituted C2-20 alkynylene group, a substituted or unsubstituted C3-12 cycloalkylene group, a substituted or unsubstituted C6-40 arylene group, or a substituted or unsubstituted C7-15 aralkylene group,

R₁₀ and R₁₁ are independently hydrogen, halogen, a substituted or unsubstituted C1-20 alkyl group, a substituted or unsubstituted C1-20 alkoxy group, a substituted or unsubstituted C6-30 aryloxy group, or a substituted or unsubstituted C6-40 aryl group.

The present invention also provide a method of preparing the above photoreactive polymer, comprising addition-polymerizing the monomer of the following Chemical Formula 1 to form a repeat unit of the Chemical Formula 3, in the presence of a catalyst composition including a precatalyst including Group 10 transition metal and a cocatalyst:

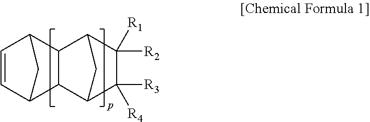

In the Chemical Formula 1, p, R₁, R₂, R₃, and R₄ are as defined in the Chemical Formula 3.

The present invention also provides a method of preparing the above photoreactive polymer, comprising subjecting the monomer of the Chemical Formula 1 to ring-opening polymerization to form a repeat unit of the Chemical Formula 4, in the presence of a catalyst composition including a precatalyst including Group 4, Group 6 or Group 8 transition metal and a cocatalyst.

The present invention also provides an alignment layer comprising the above photoreactive polymer.

The present invention also provides a liquid crystal retardation film comprising the above alignment layer and a liquid crystal layer on the alignment layer.

The present invention also provides a display device comprising the above alignment layer.

The photoreactive polymer according to the present invention may exhibit excellent thermal stability by comprising a norbornene repeat unit having high glass transition temperature as a main repeat unit. And, the photoreactive polymer may exhibit largely improved photoreaction speed and excellent alignment and photo utilization efficiency by comprising a norbornene repeat unit including a specific azo type photoreactive group in a relatively large content.

Accordingly, an alignment layer and a liquid crystal retardation film, and the like with excellent properties may be provided using the above photoreactive polymer, and process efficiency may be largely improved.

### BRIEF DESCRIPTION OF THE DRAWINGS

FIG. 1 is 1H NMR data of the polymer obtained in Example 1.

FIG. 2 is 1H NMR data of the polymer obtained in Comparative Example 1.

FIG. 3 is a graph showing the result of anisotropy and UV reactivity measured in Experimental Example 3.

### DETAILED DESCRIPTION OF THE EMBODIMENTS

Hereinafter, photoreactive polymer, a preparation method thereof, and an alignment layer comprising the same according to the embodiments of the invention will be explained in detail.

According to one embodiment, a photoreactive polymer comprising a repeat unit of the following Chemical Formula 3 or 4 in the content of 50 mol % or more of the total polymer is provided:

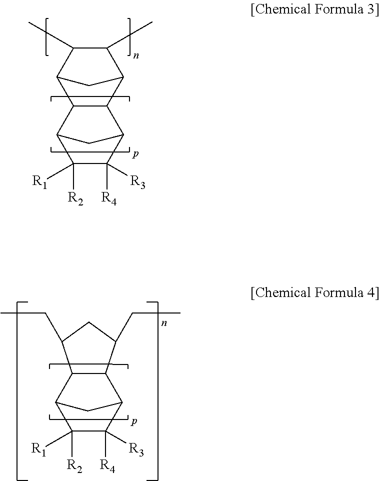

In each of the Chemical Formulae 3 and 4,

n is 50 to 5000, p is an integer of from 0 to 4,

at least one of R₁, R₂, R₃, and R₄ is a radical selected from the group consisting of the following Chemical Formulae 1a, 1b, and 1c,

the remaining R₁, R₂, R₃, and R₄ are independently selected from the group consisting of hydrogen; halogen; a substituted or unsubstituted C1-20 alkyl group; a substituted or unsubstituted C2-20 alkenyl group; a substituted or unsubstituted C2-20 alkynyl; a substituted or unsubstituted C3-12 cycloalkyl; a substituted or unsubstituted C6-40 aryl; and a polar functional group including at least one selected from oxygen, nitrogen, phosphorous, sulfur, silicon, and boron,

if R₁ to R₄ are not hydrogen; halogen; or a polar functional group, R₁ and R₂, or R₃ and R₄ may be connected to each other to form a C1-10 alkylidene group, or R₁ or R₂ may be connected to one of R₃ and R₄ to form a C4-12 saturated or unsaturated ring, or a C6-24 aromatic ring,

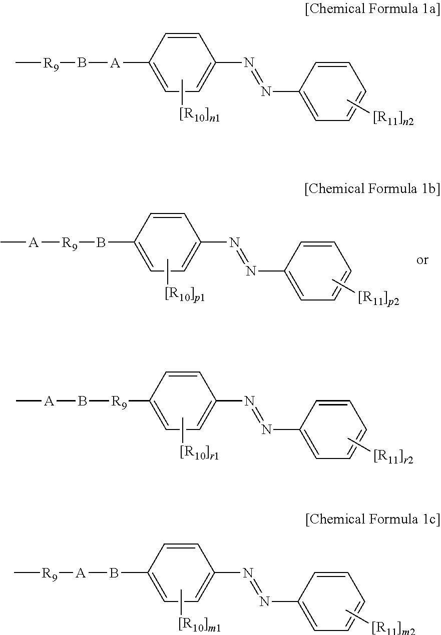

in each of the Chemical Formulae 1a, 1b, and 1c,

n1, p1, r1 and m1 is independently an integer of from 0 to 4; n2, p2, r2 and m2 are independently an integer of from 0 to 5,

A is a substituted or unsubstituted C1-20 alkylene group, a carbonyl, a carboxy, a substituted or unsubstituted C6-40 arylene group, or a bond,

B is oxygen, sulfur, —NH—, or a bond,

R₉ is a bond, a substituted or unsubstituted C1-20 alkylene group, a substituted or unsubstituted C2-20 alkenylene group, a substituted or unsubstituted C2-20 alkynylene group, a substituted or unsubstituted C3-12 cycloalkylene group, a substituted or unsubstituted C6-40 arylene group, or a substituted or unsubstituted C7-15 aralkylene group,

R₁₀ and R₁₁ are independently hydrogen, halogen, a substituted or unsubstituted C1-20 alkyl group, a substituted or unsubstituted C1-20 alkoxy group, a substituted or unsubstituted C6-30 aryloxy group, or a substituted or unsubstituted C6-40 aryl group.

The photoreactive polymer comprises a norbornene type repeat unit of the Chemical Formula 3 or 4 to which specific azo type photoreactive groups of the Chemical Formulae 1a to 1c are bonded as a main repeat unit. The norbornene type repeat unit is structurally strong, and photoreactive polymer comprising the same may exhibit excellent thermal stability compared to the existing photoreactive polymer, because it has relatively high glass transition temperature (Tg) of about 300° C. or more, preferably about 300 to 350° C. And, the photoreactive polymer may exhibit excellent alignment because photoreactive groups may relatively freely move in the polymer main chain due to the structure wherein photoreactive groups are bonded to the norbornene type repeat unit.

Further, as supported by the after-mentioned experimental examples, as results of experiments of the inventors, it was confirmed that the photoreactive polymer exhibits more rapid photoreaction speed and alignment speed than known before due to the bonding of specific azo type photoreactive groups. The azo type photoreactive group causes trans-cis isomerization toward one direction due to the absorption of polarized light by an azo group (—N═N—), and thereby functions for inducing liquid crystal alignment. It is expected that such photoreaction and alignment mechanism enables more rapid photoreaction speed and alignment speed than other photoreactive groups.

Specifically, according to one embodiment, the photoreactive polymer may comprise the repeat unit of the Chemical Formula 3 or 4 to which the azo type photoreactive groups are bonded in the high content of about 50 mole % or more, specifically about 50 to 100 mole %, more specifically about 60 to 100 mole % or about 70 to 100 mole %. Thereby, photoreaction speed may be maximized by the azo type photoreactive group. To the contrary, as supported by Comparative Examples below, if the repeat unit to which the azo type photoreactive groups are bonded is included in the low content of about 50 mole % or less, about 40 mole % or less, for example, about 20 mole %, rapid photoreaction speed may not be substantially realized by the azo type photoreactive group. The reason therefor is expected that although some of the above explained photoreaction mechanism, for example, trans-cis isomerization of the azo type photoreactive group occur, liquid alignment is not properly manifested due to low content of the azo type photoreactive group included in the alignment layer; or alignment is not made toward desired direction by the influence of other randomly disordered repeat units.

To the contrary, the photoreactive polymer according to one embodiment may exhibit excellent alignment and thermal stability as well as very rapid photoreaction speed and alignment speed, it may be preferably applied for an alignment layer of a liquid crystal display device and may largely improve process efficiency due to the rapid photoreaction speed.

Hereinafter, the photoreactive polymer will be explained in more detail.

The photoreactive polymer may comprise 100 mole % of the repeat unit selected from the group consisting of the Chemical Formulae 3 and 4, or it may further comprise other repeat units as long as it does not adversely affect the effect of the photoreactive polymer resulting from the repeat units of the Chemical Formulae 3 and 4. For example, the photoreactive polymer may be a copolymer further comprising the repeat unit of the following Chemical Formula 2a or 2b, and in this case, it may exhibit excellent thermal stability by comprising the norbornene type repeat unit of the Chemical Formula 2a or 2b.

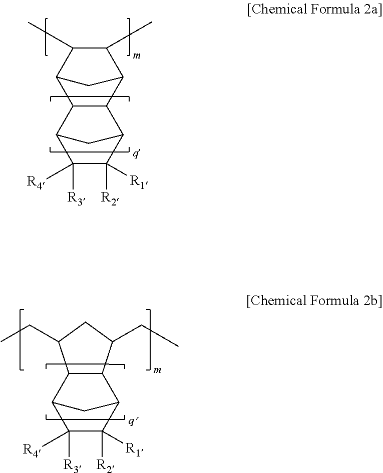

In each of the Chemical Formulae 2a and 2b,

m is 50 to 5000, q′ is an integer of from 0 to 4,

R₁′, R₂′, R₃′, and R₄′ are independently selected from the group consisting of a radical of the following Chemical Formula 2c; hydrogen; halogen; a substituted or unsubstituted C1-20 alkyl group; a substituted or unsubstituted C2-20 alkenyl group; a substituted or unsubstituted C2-20 alkynyl group; a substituted or unsubstituted C3-12 cycloalkyl group; a substituted or unsubstituted C6-40 aryl; and a polar functional group including at least one selected from oxygen, nitrogen, phosphorus, sulfur, silicon, and boron, if R₁′ to R₄′ are not hydrogen; halogen; or a polar functional group, R₁′ and R₂′, or R₃′ and R₄′ may be connected to each other to form a C1-10 alkylidene group, or R₁′ or R₂′ may be connected to one of R₃′ and R₄′ to form a C4-12 saturated or unsaturated ring, or a C6-24 aromatic ring,

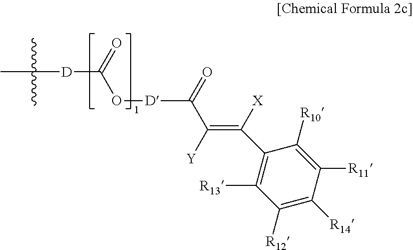

In the Chemical Formula 2c, l is 0 or 1,

D and D′ are independently selected from the group consisting of a bond, nitrogen, oxygen, sulfur, a substituted or unsubstituted C1-20 linear or branched alkylene group; a substituted or unsubstituted C3-12 cycloalkylene group; a substituted or unsubstituted C1-20 linear or branched alkylene oxide; and a substituted or unsubstituted C3-12 cycloalkylene oxide,

X and Y are independently selected from the group consisting of hydrogen; halogen; cyano; and a substituted or unsubstituted C1-20 linear or branched alkyl group,

R₁₀′ to R₁₄′ are independently selected from the group consisting of hydrogen; halogen; cyano; a substituted or unsubstituted C1-20 alkyl group; a substituted or unsubstituted C1-20 alkoxy group; a substituted or unsubstituted C6-30 aryloxy group; a substituted or unsubstituted C6-40 aryl group; a C6-40 heteroaryl group including a hetero atom of Group 14, Group 15 or Group 16; and a substituted or unsubstituted C6-40 alkoxyaryl group.

Although the repeat unit of the Chemical Formula 2a or 2b may be a general norbornene type repeat unit, it may be a photoreactive repeat unit to which a cinnamate type photoreactive group of the Chemical Formula 2c is bonded. Preferably, at least one of R₁′, R₂′, R₃′, and R₄ may be a radical of the Chemical Formula 2c, thus the repeat unit of the Chemical Formula 2a or 2b may be a photoreactive repeat unit.

If the photoreactive polymer further comprises the cinnamate type photoreactive repeat unit, it may exhibit more excellent photoreactivity and alignment. Specifically, an azo type photoreactive group exhibits photoreactivity to light in the long wavelength range closer to visible light, while the cinnamate photoreactive group tends to exhibit excellent photoreactivity to light in the short wavelength UV range. Therefore, if the photoreactive polymer further comprises the repeat unit of the cinnamate type Chemical Formula 2a or 2b together with the repeat unit of the Chemical Formula 3 or 4, when a common light source is used, light utilization efficiency may be more improved and more excellent photoreactivity and alignment may be obtained

The repeat unit of the Chemical Formula 2a or 2b may be included in the remaining content excluding the content of the Chemical Formula 3 or 4, for example in the content of greater than about 0 mol % and 50 mol % or less, more specifically greater than about 0 mol % and 40 mol % or less, or greater than about 0 mole % and 20 mole % or less. And, if at least a part of the repeat unit of the Chemical Formula 2a or 2b comprises the photoreactive group of the Chemical Formula 2c, it may be included in the content of about 10 to 50 mole %, more specifically about 20 to 50 mole % so that photoreactivity may be realized due to the repeat unit.

Meanwhile, in the repeat unit of the Chemical Formula 3 or 4 or the repeat unit of the Chemical Formula 2a or 2b making up the above explained photoreactive polymer, the polar functional group may be selected from the group consisting of the following functional groups, or other various polar functional groups including at least one selected from oxygen, nitrogen, phosphorous, sulfur, silicon, or boron may be enumerated:

—R₅OR₆, —OR₆, —OC(O)OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅₀), —OR₆, —(OR₅)ᵣ—OR₆, —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆—, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂,

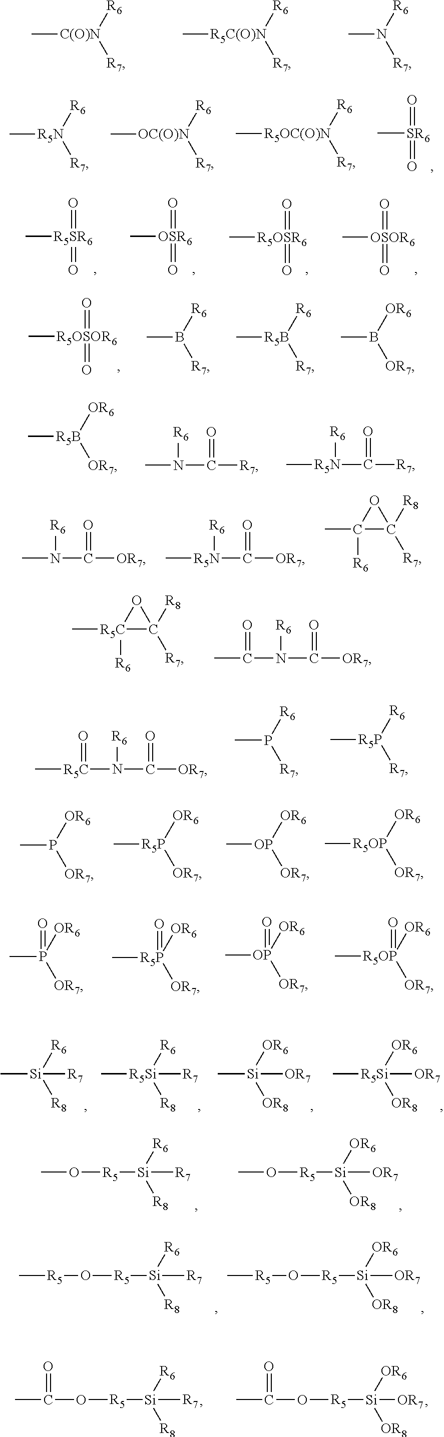

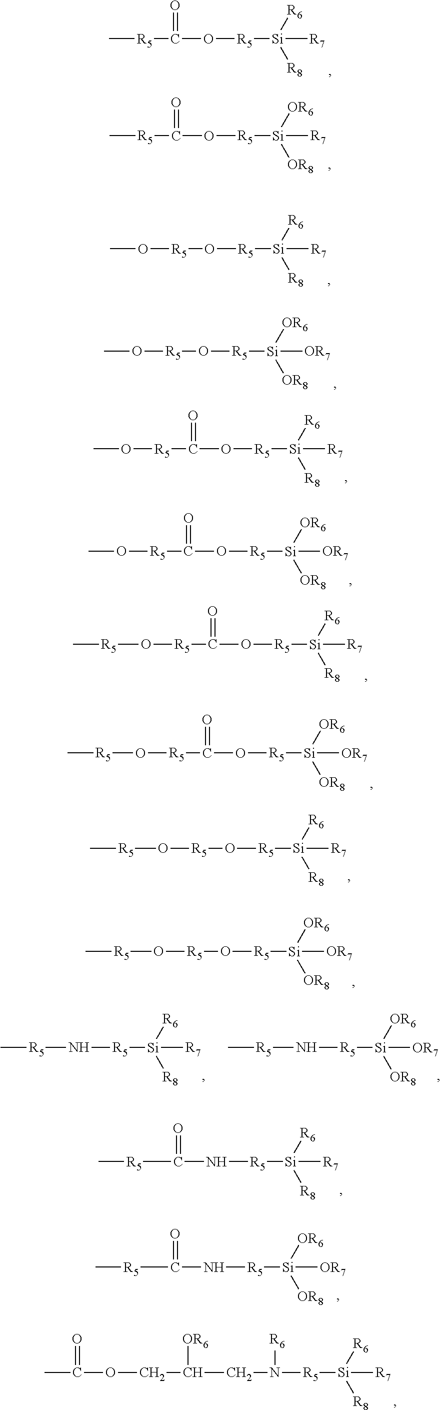

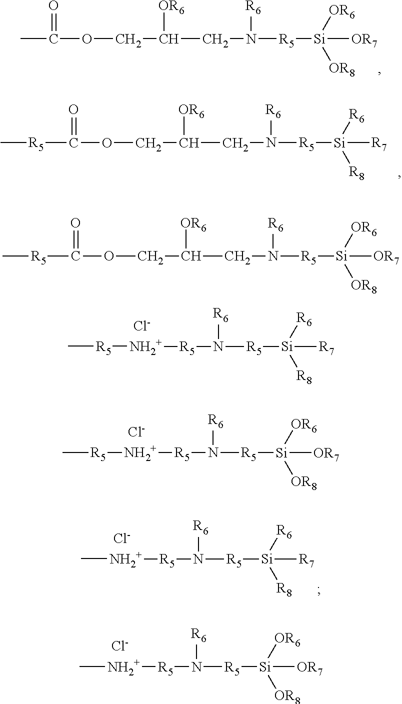

in each of the above functional groups,

r is an integer of from 1 to 10, R₅ is a substituted or unsubstituted C1-20 alkylene group; a substituted or unsubstituted C2-20 alkenylene group; a substituted or unsubstituted C2-20 alkynylene group; a substituted or unsubstituted C3-12 cycloalkylene group; a substituted or unsubstituted C6-40 arylene group; a substituted or unsubstituted C1-20 carbonyloxylene; or a substituted or unsubstituted C1-20 alkoxylene, and

R₆, R₇, and R₈ are independently selected from the group consisting of hydrogen; halogen; a substituted or unsubstituted C1-20 alkyl; a substituted or unsubstituted C2-20 alkenyl; a substituted or unsubstituted C2-20 alkynyl; a substituted or unsubstituted C3-12 cycloakyl; a substituted or unsubstituted C6-40 aryl; a substituted or unsubstituted C1-20 alkoxy; and a substituted or unsubstituted C1-20 carbonyloxy group.

Further, the repeat unit of the Chemical Formula 3 or 4, or the repeat unit of the Chemical Formula 2a or 2b making up the photoreactive polymer may have polymerization degree of about 50 to 5,000, preferably about 100 to 4000, more preferably about 1000 to 3000. If the repeat unit has a polymerization degree within the above range, the photoreactive polymer may appropriately comprise an aligning agent for forming an alignment layer to exhibit excellent coatability.

Hereinafter, in the structure of the photoreactive polymer, each substituent is described in detail:

The term “alkyl group” refers to a C1-20, preferably C1-0, more preferably C1-6 linear or branched saturated monovalent hydrocarbon moiety. The alkyl group may include those substituted by a specific substituents mentioned below as well as those unsubstituted. The examples of the alkyl group may include methyl, ethyl, propyl, 2-propyl, n-butyl, iso-butyl, tert-butyl, pentyl, hexyl, dodecyl, fluoromethyl, difluoromethyl, trifluoromethyl, chloromethyl, dichloromethyl, trichloromethyl, iodomethyl, bromomethyl, and the like.

The term “alkenyl group” refers to a C2-20, preferably C2-10, more preferably C2-6 linear or branched monovalent hydrocarbon moiety including at least one carbon-carbon double bond. The alkenyl group may be bonded through a carbon atom including a carbon-carbon double bond or a saturated carbon atom. The alkenyl group may include those substituted by a specific substituents mentioned below as well as those unsubstituted. The examples of the alkenyl group may include ethenyl, 1-propenyl, 2-propenyl, 2-butenyl, 3-butenyl, pentenyl, 5-hexenyl, dodecenyl, and the like.

The term “cycloalkyl group” refers to a C3-12 saturated or unsaturated non-aromatic monovalent monocyclic, bicyclic or tricyclic hydrocarbon moiety, and it may include those substituted by substituents mentioned below. Examples of the cycloalkyl may include cyclopropyl, cyclobutyl, cyclopentyl, cyclopentenyl, cyclohexyl, cyclohexenyl, cycloheptyl, cyclooctyl, decahydronaphthalenyl, adamantly, norbornyl (i.e., bicycle[2,2,1]hep-5-enyl), and the like.

The term “aryl group” refers to C6-40, preferably C6-12 monovalent monocyclic, bicyclic, tricyclic aromatic hydrocarbon moiety, and it may include those substituted by specific substituents mentioned below. Examples of the aryl group may include phenyl, naphthalenyl, fluorenyl, and the like.

The term “alkoxyaryl group” refers to the aryl group of which at least one hydrogen atom is substituted by an alkoxyl group. Examples of the alkoxyaryl group may include methoxyphenyl, ethoxyphenyl, propoxyphenyl, butoxyphenyl, pentoxyphenyl, hexoxyphenyl, heptoxy, octoxy, nanoxy, methoxybiphenyl, methoxynaphthalenyl, methoxyfluorenyl, methoxyanthracenyl, and the like.

The term “aralkyl group” refers to the alkyl group of which at least one hydrogen atom is substituted by an aryl group, and it may include those further substituted by specific substituents mentioned below. Examples of the aralkyl may include benzyl, benzhydryl, trityl, and the like.

The term “alkynyl group” refers to a C2-20, preferably C2-10, more preferably C2-6 linear or branched monovalent hydrocarbon moiety including at least one carbon-carbon triple bond. The alkynyl group may be bonded through a carbon atom including a carbon-carbon triple bond or through a saturated carbon atom. It may include those further substituted by specific substituents mentioned below. Examples of the alkynyl group may include ethynyl, propynyl, and the like.

The term “alkylene group” refers to a C1-20, preferably C1-10, more preferably C1-6 linear or branched saturated divalent hydrocarbon moiety. The alkylene group may include those further substituted by specific substituents mentioned below. Examples of the alkylene group may include methylene, ethylene, propylene, butylenes, hexylene, and the like.

The term “alkenylene group” refers to a C2-20, preferably C2-10, more preferably C2-6 linear or branched divalent hydrocarbon moiety including at least one carbon-carbon double bond. The alkenylene group may be bonded through a carbon atom including a carbon-carbon double bond and/or through a saturated carbon atom. The alkenylene group may include those further substituted by specific substituents mentioned below.

The term “cycloalkylene group” refers to a C3-12 saturated or unsaturated non-aromatic divalent monocyclic, bicyclic, or tricyclic hydrocarbon moiety, and it may include those further substituted by specific substituents mentioned below. Examples of the cycloalkylene group may include cyclopropylene, cyclobutylene, and the like.

The term “arylene group” refers to a C6-20, preferably C6-12 divalent monocyclic, bicyclic or tricyclic aromatic hydrocarbon moiety, and it may include those further substituted by specific substituents mentioned below. Examples of the arylnene group may include phenylene, and the like.

The term “aralkylene group” refers to a divalent moiety wherein at least one hydrogen atom of the alkyl group is substituted by an aryl group, and it may include those further substituted by specific substituents mentioned below. Examples of the aralkylene group may include benzylene, and the like.

The term “alkynylene group” refers to a C2-20, preferably C2-10, more preferably C2-6 linear or branched divalent hydrocarbon moiety including at least one carbon-carbon triple bond. The alkynylene group may be bonded through a carbon atom including a carbon-carbon triple bond, or through a saturated carbon atom. The alkynylene group may include those further substituted by specific substituents mentioned below. Examples of the alkynylene group may include ethynylene, propynylene, and the like.

The description that the above explained substituent is “substituted or unsubstituted” means that those further substituted by specific substituents as well as each substituent are included. Examples of the substituents by which each substituent may be further substituted may include halogen, an alkyl, an alkenyl, an alkynyl, a haloalkyl, a haloalkenyl, a haloalkynyl, an aryl, a haloaryl, an aralkyl, a haloaralkyl, an alkoxy, a haloalkoxy, a carbonyloxy, a halocarbonyloxy, an aryloxy, a haloaryloxy, a silyl, a siloxy group, and the like.

The above explained photoreactive polymer may exhibit photoreactivity under exposure to polarized light with a wavelength of about 150 to 450 nm, for example, about 200 to 400 nm, more specifically about 300 to 390 nm. Unlike other kinds of photoreactive groups exhibiting photoreactivity only to polarized light in the short wavelength UV range, the photoreactive groups included in the repeat unit of the Chemical Formula 3 or 4, i.e., the azo type functional groups of the Chemical Formulae 1a to 1c may exhibit excellent photoreactivity and rapid photoreaction speed even to polarized light with a long wavelength in the visible light range or close to it. Therefore, the photoreactive polymer and an alignment layer comprising the same may exhibit excellent light utilization efficiency using a common light source such as i-line, and the like. The reason therefor is that a common light source such as i-line significantly generates light with a wavelength in the visible light range or close to it. Thus, if the photoreactive polymer is used, a photoreaction and alignment may be progressed using light of a wavelength in the visible light range or close to it, which is generated from the above light source, and thus, light utilization efficiency may be more improved. Furthermore, since the photoreactive polymer may progress a photoreaction and alignment using a wider range of light generated from a light source by comprising the repeat unit of the Chemical Formula 2a or 2b having a cinnamate type photoreactive group, light utilization efficiency may be more improved.

Consequently, the photoreactive polymer may exhibit excellent photoreactivity and rapid photoreaction speed when exposed to polarized light with a wavelength of about 150 to 450 nm. More specifically, when the photoreactive polymer is exposed to polarized light with a wavelength of about 150 to 450 nm at the intensity of about 50˜900 mJ/cm², preferably about 50˜500 mJ/cm², rapid photoreaction speed may be manifested such that time (t_{1/2}) until the strength of stretching mode of a C═C bond included in the Chemical Formulae 1a to 1c becomes half of the initial value may be about 1.5 minutes or less, more specifically about 1˜1.5 minutes.

Meanwhile, according to another embodiment, a method preparing the above explained photoreactive polymer is provided. One example of the preparation method comprises addition-polymerizing the monomer of the Chemical Formula 1 to form a repeat unit of the Chemical Formula 3, in the presence of a catalyst composition including a precatalyst including Group 10 transition metal and a cocatalyst:

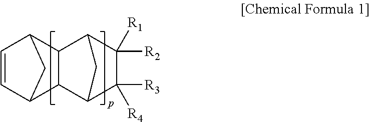

In the Chemical Formula 1, p, R₁, R₂, R₃, and R₄ are as defined in the Chemical Formula 3.

The polymerization reaction may be conducted at a temperature of from 10° C. to 200° C. If the reaction temperature is less than 10° C., polymerization activity may be lowered, and if it exceeds 200° C., a catalyst may be decomposed.

Further, the cocatalyst may include at least one selected from the group consisting of a first cocatalyst that provides a lewis base capable of weakly coordinate covalent bonding to the metal of the precatalyst, and a second cocatalyst that provides a compound including a Group 15 electron donor ligand. Preferably, the cocatalyst may be a catalyst mixture comprising the first cocatalyst providing a lewis base, and the second cocatalyst providing a compound including a Group 15 electron donor ligand.

The catalyst mixture may comprise the first cocatalyst in the content of 1 to 1000 moles, and the second cocatalyst in the content of 1 to 1000 moles, based on 1 mole of the precatalyst. If the content of the first cocatalyst or the second cocatalyst is too low, catalyst activation may not be properly made, and if it is too high, catalyst activity may be lowered.

Further, as the precatalyst including Group 10 transition metal, a compound having a lewis base functional group that easily participates in a lewis acid-base reaction and is separated from a center metal may be used so that it may be easily separated by the first cocatalyst providing a lewis base and the center transition metal may be changed into a catalyst active species. Examples of the precatalyst may include [(Allyl)Pd(Cl)]₂(Allylpalladiumchloride dimer), (CH₃CO₂)₂Pd [Palladium(II)acetate], [CH₃COCH═C(O—)CH₃]₂Pd [Palladium(II)acetylacetonate], NiBr(NP(CH₃)₃)₄, [PdCl(NB)O(CH₃)]₂, and the like.

As the first cocatalyst that provides a lewis base capable of weakly coordination covalent bonding to the metal of the precatalyst, a compound that easily reacts with a lewis base to makes an empty space of transition metal and weakly coordination covalent bonds with a transition metal compound to stabilize the generated transition metal, or a compound providing the same may be used. Examples thereof may include borane such as B(C₆F₅)₃, borate such as dimethylanilinium tetrakis(pentafluorophenyl)borate), alkylaluminum such as methylaluminoxane (MAO) or Al(C₂H₅)₃, or transition metal halide such as AgSbF₆, and the like.

As the second cocatalyst providing a compound including a neutral Group 15 electron donor ligand, alkyl phosphine, cycloalkyl phosphine or phenyl phosphine, and the like may be used.

Further, the first cocatalyst and the second cocatalyst may be separately used, or the two kinds of cocatalysts may be made into one salt and used as a compound activating a catalyst. For example, a compound made by ionic bonding of alkyl phosphine and a borane or borate compound may be used.

By the above explained method, a repeat unit of the Chemical Formula 3 and photoreactive polymer comprising the same according to one embodiment may be prepared. And, a repeat unit of the Chemical Formula 2a may be also prepared by the above method, and thereby photoreactive polymer of a copolymer type comprising the repeat unit of the Chemical Formula 3 and/or 2a may be formed.

Meanwhile, if the photoreactive polymer comprises the repeat unit of the Chemical Formula 4 or optionally comprises the repeat unit of the Chemical Formula 2b, it may be prepared according to another example of the preparation method. The preparation method according to another example comprises subjecting monomer of the Chemical Formula 1 to ring-opening polymerization to form a repeat unit of the Chemical Formula 4, in the presence of a catalyst composition comprising a precatalyst including Group 4, Group 6, or Group 8 transition metal and a cocatalyst.

In the ring-opening polymerization, if a double bond in a norbornene ring included in the monomer of the Chemical Formula 1 is hydrogenated, ring-opening may be progressed and polymerization is progressed to prepare the repeat unit of the Chemical Formula 4 and photoreactive polymer comprising the same. And, this method may be also applied for preparing a repeat unit of the Chemical Formula 2b and photoreactive polymer comprising the same.

The ring-opening polymerization may be conducted in the presence of a catalyst mixture comprising a precatalyst including Group 4 (for example, Ti, Zr, Hf), Group 6 (for example, Mo, W), or Group 8 (for example, Ru, Os) transition metal, a cocatalyst that provides a lewis base capable of weakly coordination covalent bonding with the metal of the precatalyst, and optionally, a neutral Group 15 and Group 16 activator that may enhance activity of the precatalyst metal. And, in the presence of the catalyst mixture, linear alkene such as 1-alkene, 2-alkene, and the like capable of controlling molecular weight may be added in the content of 1˜100 mol % of monomer, and polymerization may be progressed at 10° C. to 200° C.; or a catalyst including Group 4 (for example, Ti, Zr) or Groups 8 to 10 (for example, Ru, Ni, Pd) transition metal may be added in the content of 1 to 30 wt % of monomer, and hydrogenation of double bond in the norbornen ring may be progressed at 10° C. to 250° C.

If the reaction temperature is too low, polymerization activity may be lowered, and if it is too high, a catalyst may be decomposed. And, if the hydrogenation temperature is too low, hydrogenation activity may be lowered, and if it is too high, a catalyst may be decomposed.

The catalyst mixture comprises, based on 1 mole of a precatalyst including Group 4 (for example, Ti, Zr, Hf), Group 6 (for example, Mo, W), or Group 8 (for example, Ru, Os) transition metal, a cocatalyst that provides a lewis base capable of weakly coordination covalent bonding with the metal of the precatalyst in the content of 1 to 100,000 moles, and optionally, a neutral Group 15 and Group 16 activator that may enhance activity of the precatalyst metal in the content of 1 to 100 moles.

If the content of the cocatalyst is less than 1 mole, catalyst activation may not be achieved, and if it exceeds 100,000 moles, catalyst activity may be lowered. The activator may not be required according to the kinds of the precatalyst. If the content of the activator is less than 1 mole, catalyst activation may not be achieved, and if it exceeds 100 moles, molecular weight may be lowered.

If the content of the catalyst including Group 4 (for example, Ti, Zr) or Groups 8 to 10 (for example, Ru, Ni, Pd) transition metal used in the hydrogenation reaction is less than 1 wt % of monomers, hydrogenation may not be properly progressed, and if it exceeds 30 wt %, polymer may be discolored.

The precatalyst including Group 4 (for example, Ti, Zr, Hf), Group 6 (for example, Mo, W), or Group 8 (for example, Ru, Os) transition metal may include a transition metal compound such as TiCl₄, WCl₆, MoCl₅, RuCl₃ or ZrCl₄, which has a functional group that easily participates in a lewis acid-base reaction and is separated from the center metal so that it may be easily separated by the cocatalyst providing a lewis acid and the center transition metal may be changed into a catalyst active species.

As the cocatalyst that provides a lewis base capable of weakly coordination covalent bonding with the metal of the precatalyst, borane such as B(C₆F₅)₃ or borate, alkylaluminum such as methylaluminoxane (MAO) or Al(C₂H₅)₃, Al(CH₃)Cl₂, alkylaluminum halide, aluminum halide, and the like may be used. Alternatively, a substituent such as lithium, magnesium, germanium, lead, zinc, tin, silicon, and the like may be used instead of aluminum. Thus, the cocatalyst is a compound that easily reacts with a lewis base to form an empty space of transition metal, and weakly coordination covalent bonds with the transition metal compound to stabilize the generated transition metal, or a compound providing the same.

The polymerization activator may be added or it may not be required according to the kind of the precatalyst. The neutral Group 15 and Group 16 activator that may enhance activity of the precatalyst metal may include water, methanol, ethanol, isopropyl alcohol, benzyl alcohol, phenol, ethyl mercaptan, 2-chloroethanol, trimethylamine, triethylamine, pyridine, ethylene oxide, benzoyl peroxide, t-butyl peroxide, and the like.

The catalyst including Group 4 (for example, Ti, Zr) or Groups 8 to 10 (for example, Ru, Ni, Pd) transition metal used in the hydrogenation reaction may be homogeneous so as to be instantly mixed with a solvent, or it may be obtained by supporting the metal catalyst complex compound on support particles. The support may include silica, titania, silica/chromia, silica/chromia/titania, silica/alumina, aluminum phosphate gel, silanized silica, silica hydrogel, montmorillonite clay or zeolite.

By the above explained method, a repeat unit of the Chemical Formula 4 and photoreactive polymer comprising the same according to one embodiment may be prepared. And, a repeat unit of the Chemical Formula 2b may also be prepared by the above method, and thereby, photoreactive polymer of a copolymer type comprising the repeat unit of Chemical Formula 4 and/or 2b may be formed.

Meanwhile, according to another embodiment, an alignment layer comprising the above explained photoreactive polymer is provided. The alignment layer may include those in the form of a film as well as in the form of a thin layer. According to yet another embodiment, a liquid crystal retardation film comprising the alignment layer and a liquid crystal layer on the alignment layer is provided.

The alignment layer and the a liquid crystal retardation film may be manufactured using known constitutional elements and manufacturing methods, except that they comprise the above explained photoreactive polymer as photo-alignment polymer.

For example, the alignment layer may be formed by mixing the photoreactive polymer, binder resin and a photoinitiator and dissolving the mixture in an organic solvent to obtain a coating composition, and then, coating the coated composition on a substrate and progressing UV curing.

As the binder resin, acrylate resin may be used, and more specifically, pentaerythrytol triacrylate, dipentaerythrytol hexaacrylate, trimethylolpropane triacrylate, tris(2-acryloyloxiethyl)isocyanurate, and the like may be used.

As the photoinitiator, those commonly known to be usable for an alignment layer may be used without specific limitation, and for example, photoinitiator known as a product name Irgacure 907, 819 may be used.

As the organic solvent, toluene, anisol, chlorobenzene, dichloroethane, cyclohexane, cyclopentane, propyleneglycol methylether acetate, and the like may be used. Since the above explained photoreactive norbornene type copolymer has excellent solubility in various organic solvents, other various organic solvents may be used without specific limitation.

In the coating composition, a solid concentration including the photoreactive polymer, binder resin and photoinitiator may be 1 to 15 wt %, 10 to 15 wt % may be preferable for casting the alignment layer in the form of a film, and 1 to 5 wt % may be preferable for manufacturing it in the form of a thin layer.

The alignment layer may be formed on a substrate, or it may be formed under liquid crystal to function for aligning it. The substrate may include a substrate including cyclic polymer, a substrate including acryl polymer, a substrate including cellulose polymer, and the like. And, the coating composition may be coated on a substrate by various methods such as bar coating, spin coating, blade coating, and the like, and then, UV cured to form an alignment layer.

Photo-alignment may occur by the UV curing, wherein polarized UV in the wavelength range of about 150 to 450 nm may be irradiated to cause alignment. The intensity of exposure may be about 50 mJ/cm² to 10 J/cm², preferably about 500 mJ/cm² to 5 J/cm².

As the UV, polarized UV selected from the polarization-treated UV by passing or reflecting \textcircled{1} a polarizing device using a substrate wherein dielectric anisotropic material is coated on the surface of a transparent substrate such as quartz glass, soda line glass, soda line free glass, and the like, \textcircled{2} a polarizing plate on which aluminum or metal wire is finely deposited \textcircled{3} a brewster's polarizing device by reflection of quartz glass may be applied.

The temperature of the substrate when UV is irradiated may be preferably room temperature. However, according to circumstances, UV may be irradiated while heating in the temperature range of 100° C. or less. The thickness of the finally formed layer may be preferably 30 to 1000 nm.

A liquid crystal retardation film may be manufactured by forming an alignment layer by the above explained method, and forming a liquid crystal layer thereon.

The above explained alignment layer or liquid crystal retardation film may be applied for an optical film or optical filter for realizing stereoscopic images.

Therefore, according to yet another embodiment, a display device comprising the above alignment layer is provided. The display device may be a liquid crystal display device including the alignment layer for liquid crystal alignment, or a stereoscopic image display device including the alignment layer in an optical film or filter for realizing stereoscopic images, and the like. The display devices have a common device construction except including the above explained photoreactive polymer and alignment layer, and the detailed explanation is skipped.

Herein, preferable examples are presented to aid understanding of the invention. However, these examples are only to illustrate the invention, and the invention is not limited thereto.

In the following Examples, all the operations handling a compound sensitive to air or water were conducted using a standard Schlenk technique or a dry box technique. NMR spectrum was obtained using Bruker 300 spectrometer, ¹H NMR was measured at 300 MHz and ¹³C NMR was measured at 75 MHz. The molecular weight and molecular weight distribution of ring-opened hydrogenated polymer were measured using GPC (gel permeation chromatography), wherein a polystyrene sample was used as a standard. Toluene was distillated and purified from potassium/benzophenone, and dichloromethane was distilled and purified from CaH₂.

### Example 1

### Polymerization of

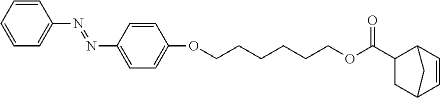

Into a 250 mL schlenk flask, 1.26 g (3 mmol) of

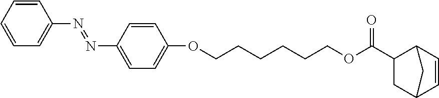

as a monomer and 3 ml of purified toluene as a solvent were introduced. Into the flask, 6.73 mg of Pd(OAc)₂ and 7.76 mg of tricyclohexylphosphine dissolved in 1 ml of dichloromethane as a catalyst, 6.53 mg of dimethylanilinium tetrakiss(pentafluorophenyl)borate as a cocatalyst were introduced, and reacted at 90° C. for 18 hours with agitation.

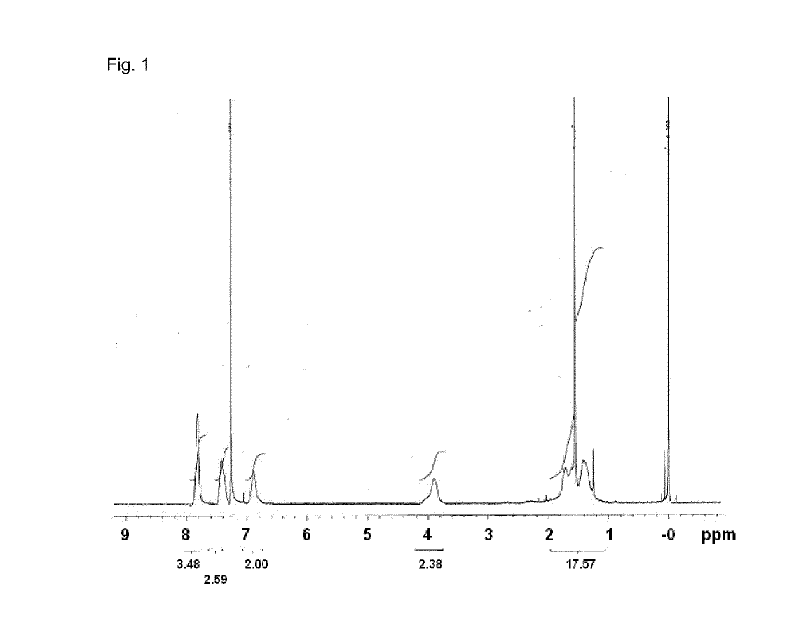

After 18 hours of the reaction, the reactant was introduced in an excessive amount of ethanol to obtain white polymer precipitate. The precipitate was filtered with a glass funnel to recover polymer, which was dried at 60° C. for 24 hours in a vacuum oven to obtain 1.19 g of polymer (Mw=31,000, PDI=1.7, yield=94%). 1H NMR data of the polymer of Example 1 was shown in FIG. 1.

### Example 2

### Polymerization of

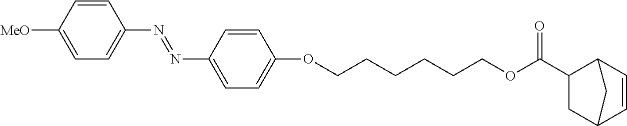

Into 1 250 mL of schlenk flask, 3.0 g (6.69 mmol) of

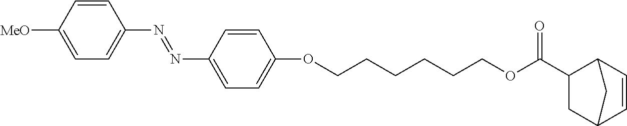

as a monomer and 4 ml of purified toluene as a solvent were introduced. Into the flask, 0.75 mg of Pd(OAc)₂ and 0.86 mg of tricyclohexylphosphine dissolved in 1 ml of dichloromethane as a catalyst, 0.72 mg of dimethylanilinium tetrakiss(pentafluorophenyl)borate as a cocatalyst were introduced, and reacted at 90° C. for 18 hours with agitation.

After 18 hours of the reaction, the reactant was introduced in an excessive amount of ethanol to obtain white polymer precipitate. The precipitate was filtered with a glass funnel to recover polymer, which was dried at 60° C. for 24 hours in a vacuum oven to obtain 2.25 g of polymer (Mw=56,000, PDI=1.9, yield=85%).

### Example 3

### Copolymerization of

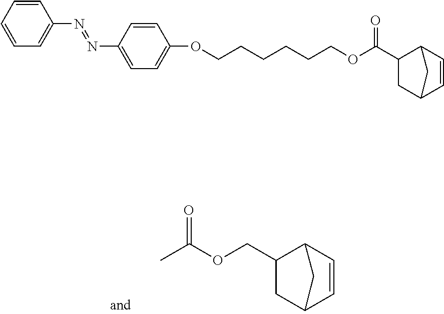

Into a 250 mL schlenk flask, 0.628 g (1.5 mmol) of

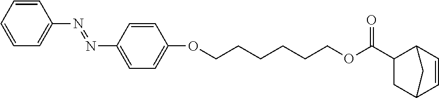

and 0.249 g (1.5 mmol) of

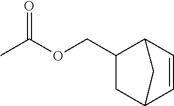

as monomers and 3 ml of purified toluene as a solvent were introduced. Into the flask, 6.73 mg of Pd(OAc)₂ and 7.76 mg of tricyclohexylphosphine dissolved in 1 ml of dichloromethane as a catalyst, 6.53 mg of dimethylanilinium tetrakiss(pentafluorophenyl)borate as a cocatalyst were introduced, and reacted at 90° C. for 18 hours with agitation.

After 18 hours of the reaction, the reactant was introduced in an excessive amount of ethanol to obtain white polymer precipitate. The precipitate was filtered with a glass funnel to recover polymer, which was dried at 60° C. for 24 hours in a vacuum oven to obtain 0.75 g of polymer (Mw=29,000, PDI=2.1, yield=86%).

### Example 4

### Polymerization of

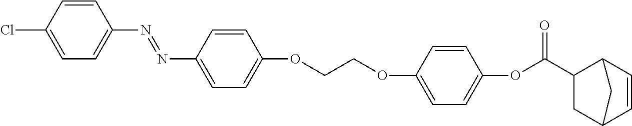

Into a 250 mL schlenk flask, 1.46 g (3 mmol) of

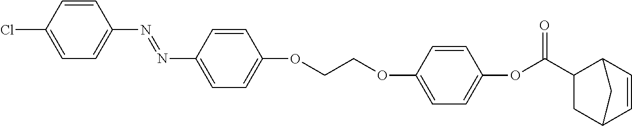

as a monomer and 3 ml, of purified toluene as a solvent were introduced. Into the flask, 6.73 mg of Pd(OAc)₂ and 7.76 mg of tricyclohexylphosphine dissolved in 1 ml of dichloromethane as a catalyst, 6.53 mg of dimethylanilinium tetrakiss(pentafluorophenyl)borate as a cocatalyst were introduced, and reacted at 90° C. for 18 hours with agitation.

After 18 hours of the reaction, the reactant was introduced in an excessive amount of ethanol to obtain yellow polymer precipitate. The precipitate was filtered with a glass funnel to recover polymer, which was dried at 60° C. for 24 hours in a vacuum oven to obtain 0.88 g of polymer (Mw=61,000, PDI=2.6, yield=64%).

### Example 5

### Polymerization of

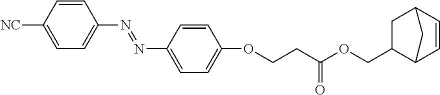

Into a 250 mL schlenk flask, 1.2 g (3 mmol) of

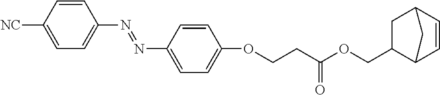

as a monomer and 3 ml of purified toluene as a solvent were introduced. Into the flask, 6.73 mg of Pd(OAc)₂ and 7.76 mg of tricyclohexylphosphine dissolved in 1 in of dichloromethane as a catalyst, 6.53 mg of dimethylanilinium tetrakiss(pentafluorophenyl)borate as a cocatalyst were introduced, and reacted at 90° C. for 18 hours with agitation.

After 18 hours of the reaction, the reactant was introduced in an excessive amount of ethanol to obtain yellow polymer precipitate. The precipitate was filtered with a glass funnel to recover polymer, which was dried at 60° C. for 24 hours in a vacuum oven to obtain 1.06 g of polymer (Mw=47,000, PDI=3.5, yield=51%).

### Example 6

### Ring Opening Methathesis Polymerization and Hydrogenation of 5-norbornene-2-methanol

Under Ar atmosphere, into a 250 ml schlenk flask, 6.20 g (50 mmol) of 5-norbornene-2-methanol was introduced, and then, 34 g of purified toluene was introduced as a solvent. Into the flask, 11.4 mg (1.0 mmol) of triethyl aluminum was introduced as a cocatalyst while maintaining the flask at a polymerization temperature of 80° C. Subsequently, 1 ml of a toluene solution wherein tungsten hexachloride (WCl₈) and ethanol are mixed at a ratio of 1:3 (WCl₈ 0.01 mmol, ethanol 0.03 mmol) was added to the flask. Finally, 0.84 g (7.5 mmol) of 1-octene was added to the flask as a molecular weight controlling agent, and then, the mixture was reacted at 80° C. for 18 hours with agitation. After the reaction was completed, a small amount of polymerization stopper ethyl vinyl ether was dropped to the polymer solution and agitated for 5 minutes.

The polymer solution was transferred to a 300 mL high pressure reactor, and then, 0.06 ml of triethyl aluminum (TEA) was added. Subsequently, 0.50 g of grace raney Nickel (slurry phase in water) was added, and then, the mixture was reacted at 150° C. for 2 hours with agitation while maintaining hydrogen pressure at 80 atm. After the reaction was completed, a polymer solution was dropped to acetone, and then, filtered and dried in a vacuum oven of 70° C. for 15 hours. As result, 5.62 g of ring-opened hydrogenated polymer of 5-norbornen-2-methanol was obtained (yield=90.6%, Mw=69,900, PDI=4.92).

### Example 7

### Synthesis of Ring-Opened Hydrogenated Polymer of

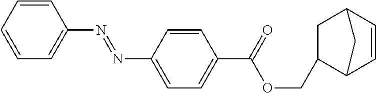

Into a 250 mL 2-neck flask, ring-opened hydrogenated polymer of 5-norbornene-2-methanol (15 g, 0.121 mol) obtained in Example 6, triethylamine (Aldrich, 61.2 g, 0.605 mol), and THF 50 ml were introduced, and then, agitated in a 0° C. ice-water bath.

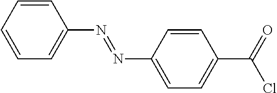

(32.5 g, 0.133 mol) was dissolved in 60 ml THF, and then, slowly introduced using an additional flask. After 10 minutes, temperature of the reactant was elevated to room temperature, and then, further agitated for 18 hours. The solution was diluted with ethyl acetate and transferred to a separatory funnel, and then, washed several times with water and NaHCO₃. And, the reactant was dropped to acetone to precipitate, and then, filtered and dried in a vacuum oven of 70° C. for 15 hours (yield: 93%).

### Example 8

### Copolymerization of

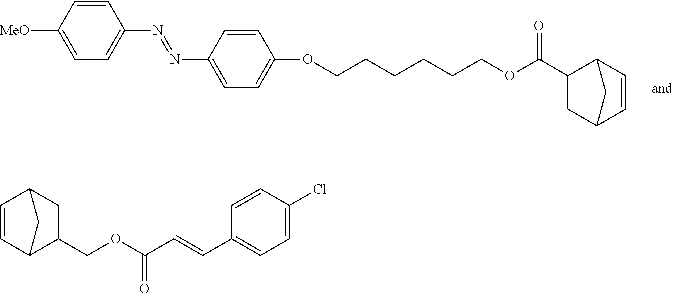

Into a 250 mL schlenk flask, 0.674 g (1.5 mmol) of

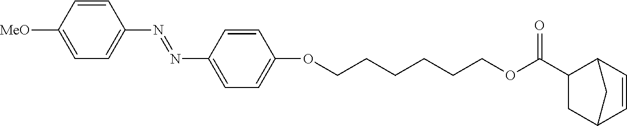

and 0.43 g (1.5 mmol) of

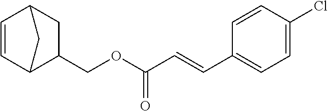

as monomers and 3 in of purified toluene as a solvent were introduced. Into the flask, 6.73 mg of Pd(OAc)₂ and 7.76 mg of tricyclohexylphosphine dissolved in 1 ml dichloromethane as a catalyst, 6.53 mg of dimethylanilinium tetrakiss(pentafluorophenyl)borate as a cocatalyst were introduced, and reacted at 90° C. for 18 hours with agitation.

After 18 hours of the reaction, the reactant was introduced in an excessive amount of ethanol to obtain light yellow polymer precipitate. The precipitate was filtered with a glass funnel to recover polymer, which was dried at 60° C. for 24 hours in a vacuum oven to obtain 0.91 g of polymer (Mw=92,000, PDI=2.96, yield=82%).

### Comparative Example 1

### Copolymerization of

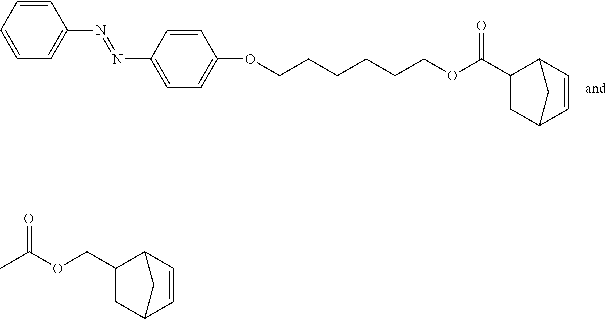

Into a 250 mL schlenk flask, 0.251 g (0.6 mmol) of

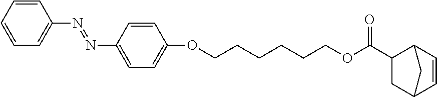

and 0.398 g (2.4 mmol) of

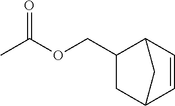

as monomers and 3 ml of purified toluene as a solvent were introduced. Into the flask, 6.73 mg of Pd(OAc)₂ and 7.76 mg of tricyclohexylphosphine dissolved in 1 ml, of dichloromethane as a catalyst, 6.53 mg of dimethylanilinium tetrakiss(pentafluorophenyl)borate as a cocatalyst were introduced, and reacted at 90° C. for 18 hours with agitation.

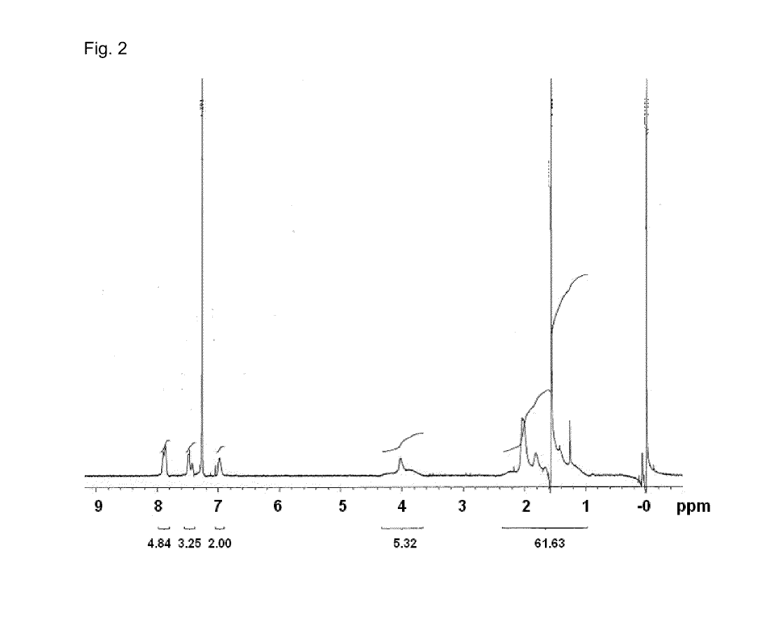

After 18 hours of the reaction, the reactant was introduced in an excessive amount of ethanol to obtain white polymer precipitate. The precipitate was filtered with a glass funnel to recover polymer, which was dried at 60° C. for 24 hours in a vacuum oven to obtain 0.53 g of polymer (Mw=26,000, PDI=1.88, yield=82%). 1H NMR data of the polymer of Comparative Example 1 was shown in FIG. 2.

### Preparation Example 1

### Manufacture of an Alignment Layer Using the Polymer of Example 1

Photoreactive polymer using the monomer

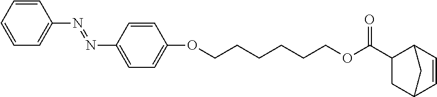

synthesized in Example 1 was dissolved in a c-pentanone solvent in a concentration of 2 wt %, and coated on a polyethylene terephthalate (product name: SH71, SKC Company) substrate with a thickness of 80 micron by roll coating such that the thickness after drying may become 1000 Å. And then, it was heated in a 80° C. oven for 3 minutes to remove a solvent in the coating layer thereby forming a coating layer.

Exposure was conducted with a light source of high pressure mercury of 200 mW/cm² intensity, and polarized UV vertical to the progression direction of the layer was generated using a wire-grid polarizer and irradiated to the coating layer, thereby providing alignment to form an alignment layer.

And then, a solid content including 95.0 wt % of UV polymeric cyano biphenyl acrylate and 5.0 wt % of Irgacure 907 (Swiss, Ciba-Geigy Company) as a photoinitiator was dissolved in toluene such that liquid crystal content may become 25 parts by weight based on 100 parts by weight of a liquid crystal solution, thus preparing a polymerizable reactive liquid crystal solution.

The prepared liquid crystal solution was dried on the above formed light alignment layer and coated to a thickness of 1 μm by roll coating, and then, dried at 80° C. for 2 minutes to align liquid crystal molecules. To the aligned liquid crystal film, non-polarized UV with a light source of high pressure mercury of 200 mW/cm² intensity was irradiated to fix the alignment state of liquid crystal thus manufacturing a retardation film.

The alignment of the manufactured retardation film was measured by measuring light leakage between polarizing plates with a transmittance, and quantitative retardation value was measured using Axoscan (Axomatrix Company).

### Comparative Preparation Example 1

An alignment layer was manufactured by the same method as Preparation Example 1, except that copolymer of

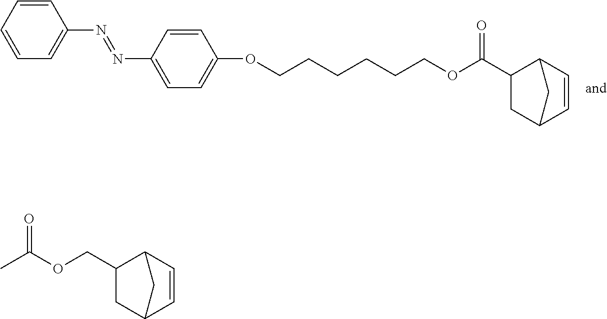

=2:8 (ratio of introduced monomer mol) was used instead of the photoreactive polymer of 100%

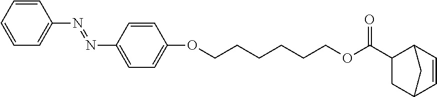

monomers of Example 1.

### Experimental Example 1

### Photoreactivity Evaluation—FT-IR Spectrum

FT-IR spectrums of the liquid crystal alignment layers manufactured in Preparation Example 1 and Comparative Preparation Example 1 were observed, and the photoreactivities of the alignment layers were comparatively evaluated based on time (t_{1/2}) until the intensity of stretching mode of C═C bond in the Chemical Formulas 1a to 1c of the polymer becomes half of the initial value upon exposure (using a mercury lamp having intensity of 20 mW/cm²), and the energy-converted value (E_{1/2}=20 mW/cm²×t_{1/2}). The results are shown in the following Table 1.

Comparison of t_{1/2} shows that t_{1/2} of Preparation Example 1 is shortened about ½ or more compared to Comparative Example 1, and thus it is confirmed that alignment speed of the liquid crystal alignment layer using the polymer of Example is excellent.

TABLE 1

| | T_{1/2} (minute) | E_{1/2 (J/cm}²) |
|---|---|---|
| Preparation | 0.9 | 1.1 |
| Example 1 | | |
| Comparative | 2.2 | 2.6 |
| Preparation | | |
| Example 1 | | |

### Experimental Example 2

### Alignment Evaluation (Evaluation of Degree of Light Leakage)

The alignment of the alignment layers were evaluated by observing the liquid crystal retardation films manufactured in Preparation Example 1 and Comparative Preparation Example 1 between vertically disposed two polarizers with a polarizing microscope. Specifically, for transmittance, based on polyethylene terephthalate (product name: SH71, Korea SKC Company) with a thickness of 80 microns, the liquid crystal retardation films manufactured in Preparation Example 1 and Comparative Preparation Example 1 were positioned between vertically disposed two polarizers, and it was observed by a polarizing microscope to what degree entering light passes the polarizing plate and retardation film and penetrates them so as to measure the degree of light leakage. The retardation film of Preparation Example 1 has uniform liquid crystal alignment direction regardless of the wavelength of entering light, while if the alignment layer of Comparative Example 1 is applied, it is confirmed that alignment performance is deteriorated and thus the alignment direction of liquid crystal waves.

### Experimental Example 3

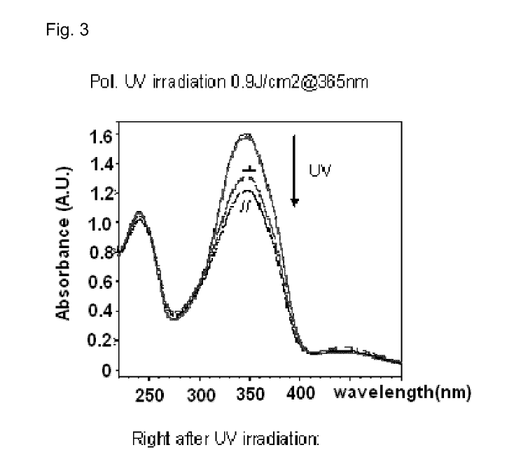

Anisotropy and UV reactivity of the photoreactive polymer synthesized in Example 1 were tested. A 2 wt % cyclopentane solution in which the polymer is dissolved was spin coated on a silicon wafer at 1000 rpm, and then, dried in a 80° C. oven for 1 minute. It was irradiated by polarized UV from a UV lamp (level 82%) having capacity of 15 mW/cm2 for about 60 minutes (0.9 J/cm2 energy irradiation based on 365 nm) and the change was measured. The result is shown FIG. 3. Referring to FIG. 3, it is confirmed that anisotropy was shown immediately after polarized UV irradiation. And, absorbance is higher when the sample is positioned vertically to the polarized UV than positioned in parallel to the polarized UV, indicating that anisotropy was formed in a vertical direction to the polarized UV. Further, it is confirmed by the experiment result that the photoreactive polymer of Example exhibits excellent photoreactivity even to polarized light of long wavelength of about 365 nm, to which the existing photoreactive polymer exhibit little photoreactivity.

1. A photoreactive polymer comprising a repeat unit of the following Chemical Formula 3 or 4 in the content of 50 mol % or more of the total polymer: 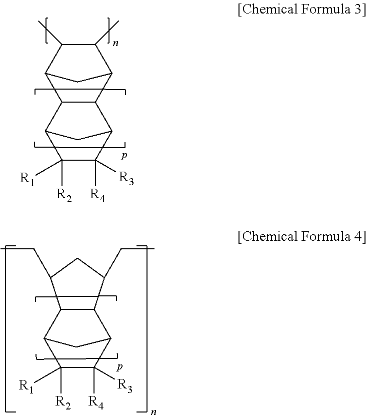
In each of the Chemical Formulae 3 and 4,
n is 50 to 5000, p is an integer of from 0 to 4,
at least one of R₁, R₂, R₃, and R₄ is a radical selected from the group consisting of the following Chemical Formulae 1a, 1b, and 1c,
remaining R₁, R₂, R₃, and R₄ are independently selected from the group consisting of hydrogen; halogen; a substituted or unsubstituted C1-20 alkyl group; a substituted or unsubstituted C2-20 alkenyl group; a substituted or unsubstituted C2-20 alkynyl; a substituted or unsubstituted C3-12 cycloalkyl; a substituted or unsubstituted C6-40 aryl; and a polar functional group including at least one selected from oxygen, nitrogen, phosphorous, sulfur, silicon, and boron,
if R₁ to R₄ are not hydrogen; halogen; or a polar functional group, R₁ and R₂, or R₃ and R₄ are connected to each other to form a C1-10 alkylidene group, or R₁ or R₂ is connected to one of R₃ and R₄ to form a C4-12 saturated or unsaturated ring, or a C6-24 aromatic ring, 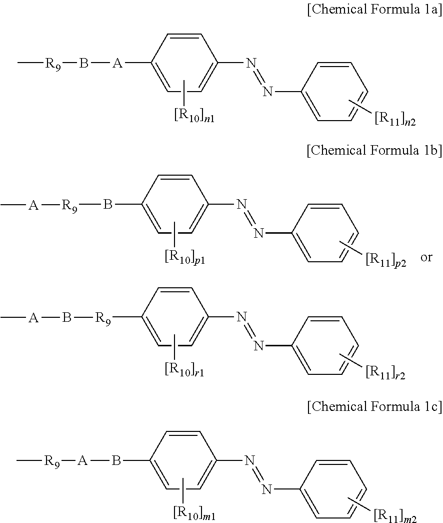
In each of the Chemical Formulae 1a, 1b, and 1c,
n1, p1, r1 and m1 is independently an integer of from 0 to 4; n2, p2, r2 and m2 are independently an integer of from 0 to 5,
A is a substituted or unsubstituted C1-20 alkylene group, a carbonyl, a carboxy, a substituted or unsubstituted C6-40 arylene group, or a bond,
B is oxygen, sulfur, —NH—, or a bond,
R₉ is a bond, a substituted or unsubstituted C1-20 alkylene group, a substituted or unsubstituted C2-20 alkenylene group, a substituted or unsubstituted C2-20 alkynylene group, a substituted or unsubstituted C3-12 cycloalkylene group, a substituted or unsubstituted C6-40 arylene group, or a substituted or unsubstituted C7-15 aralkylene group,
R₁₀ and R₁₁ are independently hydrogen, halogen, a substituted or unsubstituted C1-20 alkyl group, a substituted or unsubstituted C1-20 alkoxy group, a substituted or unsubstituted C6-30 aryloxy group, or a substituted or unsubstituted C6-40 aryl group.

2. The photoreactive polymer according to claim 1, further comprising a repeat unit of the following Chemical Formula 2a or 2b: 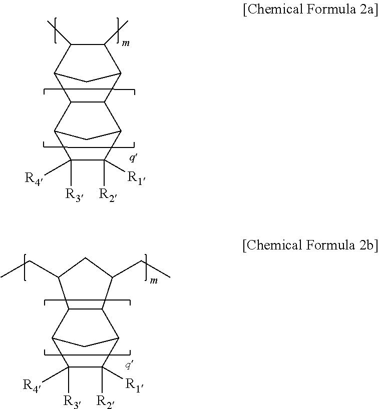
In each of the Chemical Formulae 2a and 2b,
m is 50 to 5000, and q′ is an integer of from 0 to 4,
R₁′, R₂′, R₃′ and R₄′ are independently a radical of the following Chemical Formula 2c; hydrogen; halogen; a substituted or unsubstituted C1-20 alkyl group; a substituted or unsubstituted C2-20 alkenyl group; a substituted or unsubstituted C2-20 alkynyl group; a substituted or unsubstituted C3-12 cycloalkyl group; a substituted or unsubstituted C6-40 aryl; and a polar functional group including at least one selected from oxygen, nitrogen, phosphorus, sulfur, silicon, and boron,
if R₁′ to R₄′ are not hydrogen; halogen; or a polar functional group, R₁′ and R₂′, or R₃′ and R₄′ are connected to each other to form a C1-10 alkylidene group, or R₁′ or R₂′ is connected to one of R₃′ and R₄′ to form a C4-12 saturated or unsaturated ring, or a C6-24 aromatic ring, 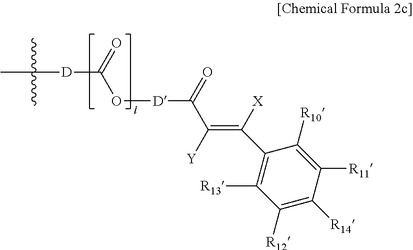
In the Chemical Formula 2c, 1 is 0 or 1,
D and D′ are independently selected from the group consisting of a bond, nitrogen, oxygen, sulfur, a substituted or unsubstituted C1-20 linear or branched alkylene group; a substituted or unsubstituted C3-12 cycloalkylene group; a substituted or unsubstituted C1-20 linear or branched alkylene oxide; and a substituted or unsubstituted C3-12 cycloalkylene oxide,
X and Y are independently selected from the group consisting of hydrogen; halogen; cyano; and a substituted or unsubstituted C1-20 linear or branched alkyl group,
R₁₀′ to R₁₄′ are independently selected from the group consisting of hydrogen; halogen; cyano; a substituted or unsubstituted C1-20 alkyl group; a substituted or unsubstituted C1-20 alkoxy group; a substituted or unsubstituted C6-30 aryloxy group; a substituted or unsubstituted C6-40 aryl group; a C6-40 heteroaryl group including a hetero atom of Group 14, Group 15 or Group 16; and a substituted or unsubstituted C6-40 alkoxyaryl group.

3. The photoreactive polymer according to claim 2, wherein at least one of R₁′, R₂′, R₃′, and R₄′ is a radical of the Chemical Formula 2c.

4. The photoreactive polymer according to claim 1, wherein the polar functional group is selected from the group consisting of the following functional groups:
—R₅OR₆, —OR₆, —OC(O)OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)ᵣ—OR₆, —(OR₅)ᵣOR₆, —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆—, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂, 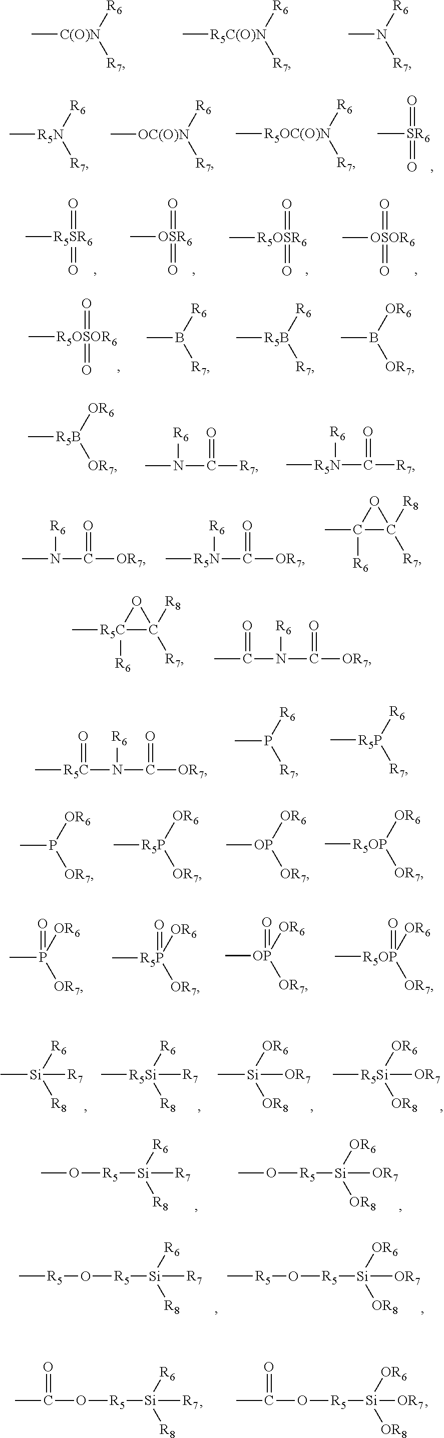 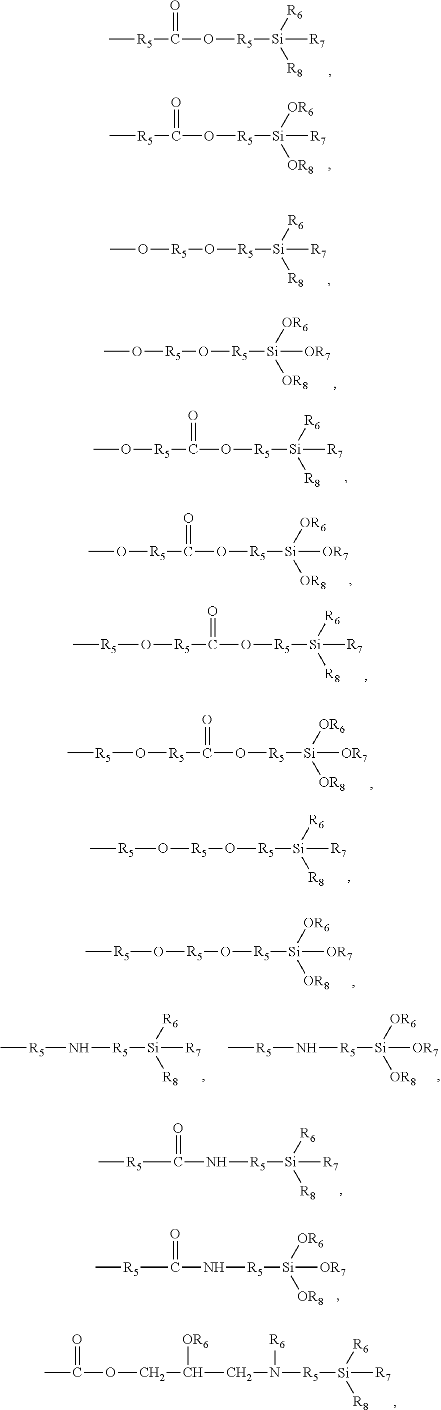 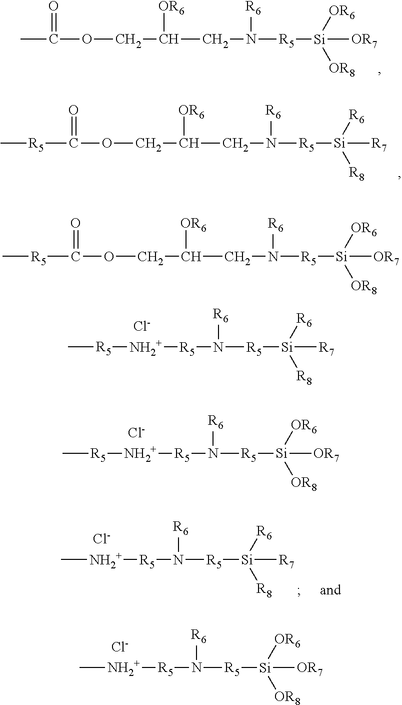
in each of the above functional groups,
r is an integer of from 1 to 10, R₅ is a substituted or unsubstituted C1-20 alkylene group; a substituted or unsubstituted C2-20 alkenylene group; a substituted or unsubstituted C2-20 alkynylene group; a substituted or unsubstituted C3-12 cycloalkylene group; a substituted or unsubstituted C6-40 arylene group; a substituted or unsubstituted C1-20 carbonyloxylene; or a substituted or unsubstituted C1-20 alkoxylene,
R₆, R₇, and R₈ are independently selected from the group consisting of hydrogen; halogen; a substituted or unsubstituted C1-20 alkyl; a substituted or unsubstituted C2-20 alkenyl; a substituted or unsubstituted C2-20 alkynyl; a substituted or unsubstituted C3-12 cycloakyl; a substituted or unsubstituted C6-40 aryl; a substituted or unsubstituted C1-20 alkoxy; and a substituted or unsubstituted C1-20 carbonyloxy group.

5. The photoreactive polymer according to claim 1, wherein the photoreactive polymer comprises 100 mole % of at least one repeat unit selected from the group consisting of the repeat units of the Chemical Formulae 3 and 4.

6. The photoreactive polymer according to claim 2, wherein the photoreactive polymer comprises 50 mole % or more and less than 100 mole % of at least one repeat unit selected from the group consisting of the Chemical Formulae 3 and 4, and more than 0 mole % and 50 mole % or less of at least one repeat unit selected from the group consisting of the Chemical Formula 2a and 2b.

7. The photoreactive polymer according to claim 1, wherein the photoreactive polymer exhibits photoreactivity under exposure to polarized light with a wavelength of 150 to 450 nm.

8. The photoreactive polymer according to 7, wherein when polarized light with a wavelength of 150 to 450 nm is exposed with energy of 50˜900 mJ/cm², time (t_{1/2}) until the strength of stretching mode of a C═C bond included in the Chemical Formulae 1a to 1c becomes half of the initial value is 1.5 minutes or less.

9. A method of preparing the photoreactive polymer of claim 1, comprising addition-polymerizing the monomer of the following Chemical Formula 1 to form a repeat unit of the Chemical Formula 3, in the presence of a catalyst composition including a precatalyst including Group 10 transition metal and a cocatalyst: 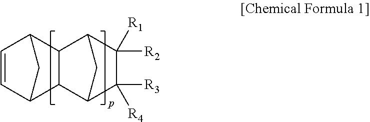
In the Chemical Formula 1, p, R₁, R₂, R₃, and R₄ are as defined in the Chemical Formula 3.

10. A method of preparing the photoreactive polymer of claim 1, comprising subjecting the monomer of the following Chemical Formula 1 to ring-opening polymerization to form a repeat unit of the Chemical Formula 4, in the presence of a catalyst composition including a precatalyst including Group 4, Group 6 or Group 8 transition metal and a cocatalyst: 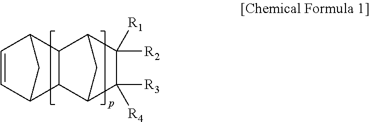
In the Chemical Formula 1, p, R₁, R₂, R₃, and R₄ are as defined in the Chemical Formula 4.

11. The method according to claim 10, wherein in the ring-opening polymerization, a double bond in a norbornene ring included in the monomer of the Chemical Formula 1 is hydrogenated to progress ring-opening and polymerization.

12. An alignment layer comprising the photoreactive polymer of claim 1.

13. A liquid crystal retardation film comprising the alignment layer of claim 12 and a liquid crystal layer on the alignment layer.

14. A display device comprising the alignment layer of claim 12.
